(19) United States
(12) Patent Application Publication
(10) Pub. No.: US 2013/0067591 A1
(43) Pub. Date: Mar. 14, 2013

(54) METHOD FOR FILTERING WEB PAGE CONTENT AND NETWORK EQUIPMENT WITH WEB PAGE CONTENT FILTERING FUNCTION

(71) Applicants: Li-Der CHOU, Taoyuan County (TW); Hua-Rong CHU, New Taipei City (TW); Hsu-Chuan WEI, Hsinchu City (TW); Neng-Hsing CHEN, Hsinchu City (TW)

(72) Inventors: Li-Der CHOU, Taoyuan County (TW); Hua-Rong CHU, New Taipei City (TW); Hsu-Chuan WEI, Hsinchu City (TW); Neng-Hsing CHEN, Hsinchu City (TW)

(73) Assignees: PROSCEND COMMUNICATIONS INC., Hsinchu City (TW); NATIONAL CENTRAL UNIVERSITY, TAOYUAN COUNTY (TW)

(21) Appl. No.: 13/248,041

(22) Filed: Sep. 29, 2011

(30) Foreign Application Priority Data
Sep. 13, 2011 (TW) 100132879

(51) Int. Cl. G06F 21/20; G06F 15/16

(52) U.S. Cl. 726/27

(57) ABSTRACT

A method for filtering web page content is disclosed in this invention. In the method, a web page request to obtain a web page from a web server is received from a client through a network equipment after the client builds a connection with the web server. The network equipment transmits the web page request to a cloud server for determining if the web page needs to be blocked according to the web page request. A first disconnection request and a second disconnection request is generated according to the web page request if it is determined that the web page needs to be blocked. The first disconnection request is transmitted to the client and the second disconnection request is transmitted to the web server through the network equipment. Subsequently, the connection between the client and the web server is disconnected.

### RELATED APPLICATIONS

This application claims priority to Taiwan Application Serial Number 100132879 filed Sep. 13, 2011, which is herein incorporated by reference.

### BACKGROUND

1. Technical Field

The present invention relates to a method for filtering a web page content and a network equipment applying the method. More particularly, the present invention relates to a method for filtering a web page content and a network equipment applying the method.

2. Description of Related Art

As the developing of the networks, all kinds of contents are available of networks. Pornography of the web brings non-ignorable influence on minors who make up a large proportion of Internet population. Nowadays, 12% of the websites on Internet are pornographic, and 25% of search requests are pornography related. Educators emphasize the importance that parents should accompany their school-aged children to surf the Internet. But, in fact, it's hard to realize since parents are too busy to spare their time for accompanying their school-aged children. As a result, only 6.8% of teenagers surf web with their parents, however about 90% of teenagers have watched pornographic videos or visited pornographic websites in Taiwan. Hence, web filtering is a choice to mitigate the problem.

Web filtering is the technique whereby web request is blocked or allowed according to its corresponding contents. When a user makes a request for a specific resource, such as words or videos, on the web server via networks, a client device would send out the request. The request is sent to the web server, which provide the requested resource, through network nodes, and the web server return a corresponding response to complete a HTTP transaction. During the transaction, the packets of the request and the response may pass through many network nodes, such as the user's client device, the web server, the home gateway, the Concentrator in central office, the edge router or any other network nodes. A web filter function can be performed by the network nodes thereof to inspect and intercept network traffic passing through them.

Most studies focus on how to filter web contents with limited delay or how to precisely determine if web contents are pornographic or not. However, such studies need to widely deploy many network equipments with the web filter function, which may costs a lot.

Hence, there is a need to provide the web filter function by network equipments with low costs.

### SUMMARY

According to one embodiment of this invention, a method for filtering web page content is provided to determine if a web page, which is requested to a web server by a client, utilizing a cloud server after the client builds a connection with the web server. If the requested web page needs to be blocked, disconnection requests are transmitted to the client and the web server to disconnect the connection between them. The method for filtering web page content includes the following operations:

(a) a web page request, which is utilized to obtain a web page from a web server, is received from a client through a network equipment after the client builds a connection with the web server.

(b) the network equipment transmits the web page request to a cloud server.

(c) the cloud server determines if the web page needs to be blocked according to the web page request.

(d) a first disconnection request and a second disconnection request is generated according to the web page request if it is determined that the web page needs to be blocked. Wherein, the first disconnection request is utilized to request the client to disconnect from the web server, and the second disconnection request is utilized to simulate that the client requests to disconnect from the web server.

(e) the first disconnection request is transmitted to the client and the second disconnection request is transmitted to the web server through the network equipment, such that the connection between the client and the web server is disconnected.

According to another embodiment of this invention, a network equipment with a web page content filtering function is provided to determine if a web page, which is requested to a web server by a client, utilizing a cloud server after the client builds a connection with the web server. If the requested web page needs to be blocked, the network equipment transmits disconnection requests to the client and the web server to disconnect the connection between them. The network equipment includes a connection building module, a web-page-request receiving module, a web-page-request transmitting module, a disconnecting-request receiving module and a disconnecting-request transmitting module. A client builds a connection with a web server through the connection building module. The web-page-request receiving module receives a web page request, which is utilized to obtain a web page from the web server, from the client. The web-page-request transmitting module transmits the web page request to a cloud server. Hence, the cloud server determines if the web page needs to be blocked according to the web page request. The disconnecting-request receiving module receives a first disconnection request and a second disconnection request from the cloud server if it is determined that the web page needs to be blocked. Wherein, the first disconnection request is utilized to request the client to disconnect from the web server, and the second disconnection request is utilized to simulate that the client requests to disconnect from the web server. The disconnecting-request transmitting module transmits the first disconnection request to the client and transmits the second disconnection request to the web server. Subsequently, the connection between the client and the web server is disconnected.

The present invention can achieve many advantages. The cloud server can be utilized to assist for determining if request web pages need to be blocked or not. As a result, the network equipment can provide the web page content filtering function even if the network equipment is not equipped with good calculation ability. In addition, the network equipment only needs to transmit the received web page request to the cloud server, but does not have to transmit the content of the requested web page to the cloud server for the block-or-not determination. Hence, the bandwidth of the network equipment can be saved. Furthermore, if the web page needs to be blocked, the resource of the client and the web server reserved for keeping the connection between them can be saved by the disconnection requests.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 illustrates a flow diagram of a method for filtering web page content according to an embodiment of this invention;

FIG. 2 illustrates an embodiment of a system applying the method for filtering web page content in FIG. 1; and

FIG. 3 illustrates a block diagram will be described that illustrates a network equipment with a web page content filtering function according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

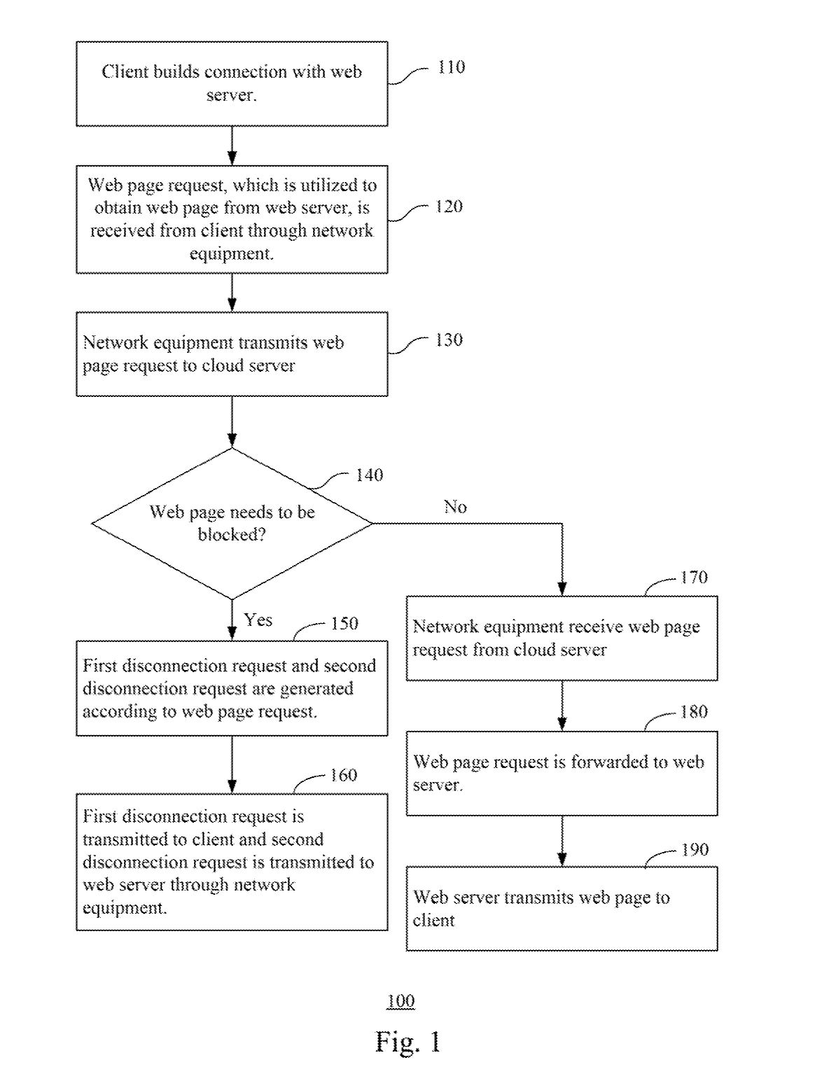

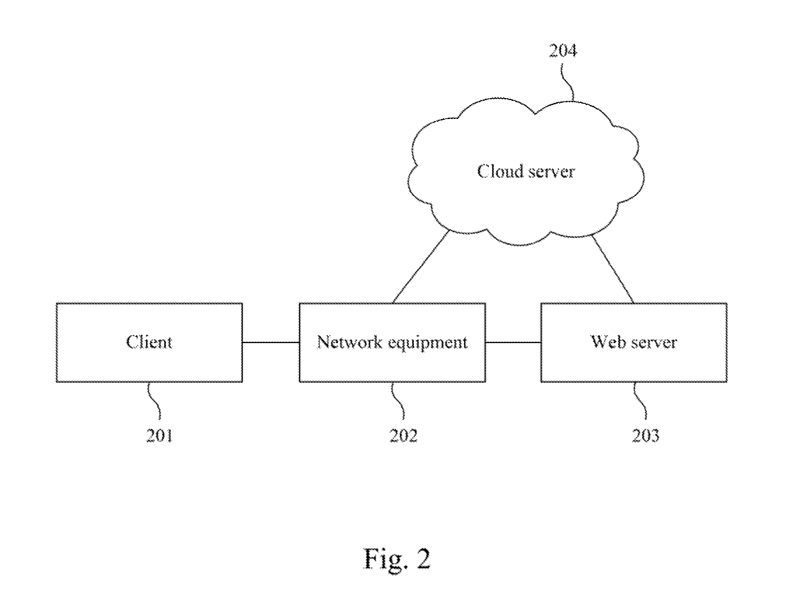

FIG. 1 illustrates a block diagram will be described that illustrates a method for filtering web page content according to an embodiment of this invention. In the method for filtering web page content, a cloud server is utilized to determine if a web page, which is requested to a web server by a client, after the client builds a connection with the web server. If the requested web page needs to be blocked, disconnection requests are transmitted to the client and the web server to disconnect the connection between them. The method for filtering web page content may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. FIG. 2 illustrates an embodiment of a system applying the method for filtering web page content in FIG. 1.

The routine 100 for the method for filtering web page content starts at operation 110, where a client 201 builds a connection with a web server 203 through a network equipment 202. In one embodiment, the client 201 may utilize a three-way handshake in Transmission Control Protocol (TCP) to establish a TCP session with the web server 203 through the network equipment 202 for building a connection between the client 201 and the web server 203 at operation 110. The network equipment 202 may be a firewall of a local area network (LAN), a filtering equipment of a LAN, a computer for executing a network filtering software, a network equipment for connecting to the layer upper than layer 3 of Ethernet, a network equipment for connecting to the layer upper than layer 3 of a kernel network or any other network equipment.

Hence, from operation 110, the routine 100 continues to operation 120, where a web page request, which is utilized to obtain a web page from the connected web server 203, is received from the client 201 through the network equipment 202. In one embodiment of this invention, after the client 202 builds a connection with the web server 203 (operation 110), the network equipment 202 may keep determining if packets transmitted from the client 201 is a hypertext transfer protocol (HTTP) GET request. If the packet transmitted from the client 201 is a HTTP GET request and the requested target is the web server 203, it is determined that receiving a web page request at operation 120 is executed.

At operation 130, the network equipment 202 transmits the web page request received at operation 120 to a cloud server 204. In one embodiment of this invention, a tunnel may be established between the network equipment 202 and the cloud server 204 in advance. Subsequently, the network equipment 202 may transmit the web page request to the cloud server 204 through the established tunnel (operation 130). In practical, the network equipment 202 may pack the web page request into a tunnel packet for transmitting the web page request to the cloud server 204 through the tunnel.

The routine 100 continues to operation 140, where the cloud server 204 determines if the web page needs to be blocked according to the web page request. During executing operation 140, an ACK packet may be continually transmitted to the client 201, which can avoid that the client closes the TCP session for timeout due to no response for a period of time.

If the cloud server 204 determines that the web page needs to be blocked, the routine 100 continues to operation 150, where a first disconnection request and a second disconnection request is generated according to the web page request. Wherein, the first disconnection request is utilized to request the client 201 to disconnect from the web server 203, and the second disconnection request is utilized to simulate that the client 201 requests to disconnect from the web server 203.

Subsequently, at operation 160, the first disconnection request is transmitted to the client 201 and the second disconnection request is transmitted to the web server 203 through the network equipment 202. Hence, the connection between the client 201 and the web server 203 is disconnected. Therefore, the cloud server 204 can be utilized to assist for determining if request web pages need to be blocked or not. As a result, the network equipment 202 can provide the web page content filtering function even if the network equipment 202 is not equipped with good calculation ability. In addition, the network equipment 202 only needs to transmit the received web page request to the cloud server 204, but does not have to transmit the content of the requested web page to the cloud server 204 for the block-or-not determination. Hence, the bandwidth of the network equipment 202 can be saved. Furthermore, if the web page needs to be blocked, the resource of the client 201 and the web server 203 reserved for keeping the connection between them can be saved by the disconnection requests.

In one embodiment of this invention, address information of the client 201 (for example, IP address of the client 201) can be analyzed according to the web page request to generate the first disconnection request for transmitting to the client 201 at operation 150. In addition, TCP FIN-ACK packet can be utilized as the first disconnection request at operation 150. Subsequently, after the client 201 receives the TCP FIN-ACK packet (the first disconnection request), the client 201 may switch to TCP half-close status to disconnect from the web server 203. Furthermore, before transmitting the first disconnection request to the client 201 at operation 160, address information (for example, IP address) of the client 201 and the web server 203 can be analyzed according to the web page request and a HTTP Response, source of which is the web server 203, can be faked and sent to the client 201. Hence, the client 201 may take the received HTTP Response as the response transmitted from the web server 203 and determines that the requested web page is transmitted from the web server 203. In some embodiments, the faked HTTP Response may be a Forge Response or any other HTTP Response.

In another response of this invention, address information of the web server 203 (for example, IP address of the web server 203) can be analyzed according to the web page request to generate a TCP RST packet, which is taken as the second disconnection request, at operation 150. Subsequently, after the web server 203 receives the TCP RST packet (the second disconnection request), the web server 203 may close the TCP Session.

If the cloud server determines that the web page does not need to be blocked, the routine 100 may continue to operation 170, where the network equipment 202 receives the web page request from the cloud server 204.

From operation 170, the routine 100 may continue to operation 180, where the network equipment 202 forwards the web page request, which is received from the cloud server 204, to the web server 203. Hence, at operation 190, the web server 203 transmits the web page to the client 201 according to the web page request. Therefore, during the determination at operation 140, extra spaces for storing the web page request from the client 201 are not needed. In other words, the network equipment 202 can be equipped with memories with smaller storage spaces.

In one embodiment of this invention, the cloud server 204 may transmit the web page request to the network equipment 202 through the established tunnel between the cloud server 204 and the network equipment 202 for the network equipment 202 to receive at operation 170. In practical, the cloud server 204 may pack the web page request into a tunnel packet for transmitting the web page request to the network equipment 202 through the tunnel. Subsequently, when the network equipment 202 receives the tunnel packet with the web page request, the network equipment 202 may retrieve the web page request from the tunnel packet for forwarding to the web server 203 at operation 180.

In one embodiment of operation 140, the cloud server 204 may determine if the web page needs to be blocked by determining the address requested in the web page request is listed in a black list or a white list. Hence, the web page request may include an address of the web page. In one embodiment of the operation 140, the cloud server may determine if the address of the web page is listed in a black list or a white list. If the address of the web page is listed in the black list, the cloud server 204 determines that the web page needs to be blocked. If the address of the web page is listed in the white list, the cloud server 204 determines that the web page does not need to be blocked. Therefore, only the address in the web page request is needed for determining if the web page needs to be blocked or not, which can save calculation resources of the cloud server 204.

In addition, if the address of the web page is listed in neither the black list nor the white list, the cloud server 204 may further obtain the web page from the address of the requested web page for determination. Hence, if the address of the web page is listed in neither the black list nor the white list, the cloud server 204 may obtain the web page from the web server 204 according to the address of the web page. The cloud server 204 analyzes the obtained web page to determine if the web page needs to be blocked. If the cloud server 204 determines that the web page needs to be blocked after analysis, the cloud server 204 adds the address of the web page into the black list. If the cloud server 204 determines that the web page does not need to be blocked after analysis, the cloud server 204 adds the address of the web page into the white list. Therefore, the address, that the cloud server 204 is able to determine to block or not, can be extended.

In one embodiment of this invention, the cloud server 204 may eliminate codes, that request for other web page sources, in the source codes of the web page without analyzing. Hence, it can speed up the analysis done by the cloud server 204, which can decrease the waiting time for the client 201. In addition, other requested web page sources in the web page may still need other request packets for obtaining. As a result, the extra requested web page sources can still be analyzed according to the extra request corresponding to thereof without neglects.

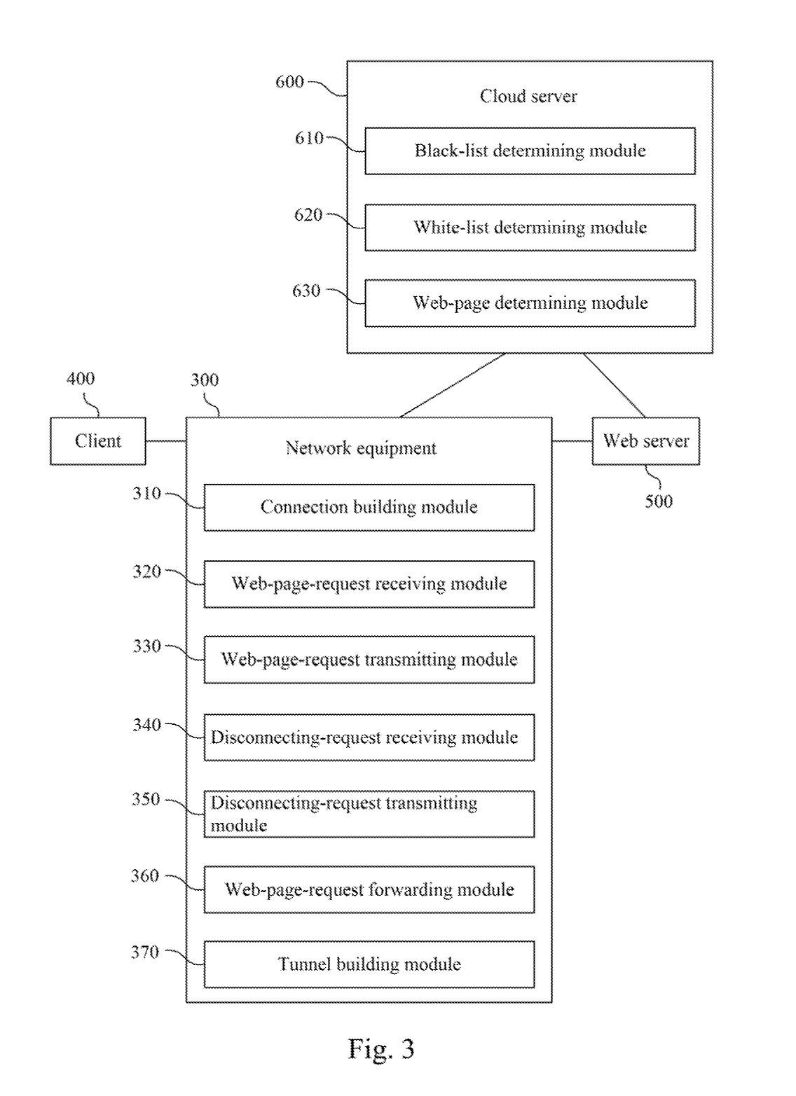

Referring to FIG. 3, a block diagram will be described that illustrates a network equipment with a web page content filtering function according to an embodiment of this invention. The network equipment determines if a web page, which is requested to a web server by a client, utilizing a cloud server after the client builds a connection with the web server. If the requested web page needs to be blocked, the network equipment transmitted disconnection requests to the client and the web server to disconnect the connection between them. The network equipment may be a firewall of a LAN, a filtering equipment of a LAN, a computer for executing a network filtering software, a network equipment for connecting to the layer upper than layer 3 of Ethernet, a network equipment for connecting to the layer upper than layer 3 of a kernel network or any other network equipment. The modules in the network equipment may be implemented utilizing a central processing unit (CPU), a control unit or any other hardware unit with calculation ability of the network equipment.

The network equipment 300 includes a connection building module 310, a web-page-request receiving module 320, a web-page-request transmitting module 330, a disconnecting-request receiving module 340 and a disconnecting-request transmitting module 350. A client 400 builds a connection with a web server 500 through the connection building module 310. In one embodiment of this invention, In one embodiment, the client 400 may utilize a three-way handshake in TCP to establish a TCP session with the web server 500 through the connection building module 310 for building a connection between the client 400 and the web server 500 at operation 110.

The web-page-request receiving module 320 then receives a web page request, which is utilized to obtain a web page from the connected web server 500, from the client 400. In one embodiment of this invention, after the client 400 builds a connection with the web server 500, the web-page-request receiving module 320 may keep determining if packets transmitted from the client 400 is a HTTP GET request. If the packet transmitted from the client 400 is a HTTP GET request and the requested target is the web server 500, the web-page-request receiving module 320 determines that a web page request is received from the client 400.

The web-page-request transmitting module 330 transmits the web page request to a cloud server 600. In one embodiment of this invention, a tunnel building module 370 of the network equipment 300 may build a point-to-point tunnel to the cloud server 600. Subsequently, the web-page-request transmitting module 330 may pack the web page request into a tunnel packet for transmitting to the cloud server 600. In other embodiments, the web-page-request transmitting module 330 may utilize other transmission method for transmitting the web page request to the cloud server 600, which should not be limited in this disclosure.

Hence, the cloud server 600 determines if the web page needs to be blocked according to the web page request. In one embodiment of this invention, the cloud server 600 may retrieve the web page request from the tunnel packet for determination thereof.

If the cloud server 600 determines that the web page needs to be blocked, the cloud server 600 generates a first disconnection request and a second disconnection request for transmitting to the network equipment 300. The first disconnection request is utilized to request the client 400 to disconnect from the web server 500, and the second disconnection request is utilized to simulate that the client 400 requests to disconnect from the web server 500. Subsequently, the disconnecting-request receiving module 340 receives the first disconnection request and the second disconnection request from the cloud server 600. In one embodiment of this invention, the cloud server 600 may pack the first disconnection request and the second disconnection request into at least one tunnel packet to transmit to the disconnecting-request receiving module 340 through the tunnel.

The disconnecting-request transmitting module 350 transmits the first disconnection request to the client 400 and transmits the second disconnection request to the web server 500. Subsequently, the connection between the client 400 and the web server 500 is disconnected. Therefore, the cloud server 600 can be utilized to assist for determining if request web pages need to be blocked or not. As a result, the network equipment 300 can provide the web page content filtering function even if the network equipment 300 is not equipped with good calculation ability. In addition, the network equipment 300 only needs to transmit the received web page request to the cloud server 600, but does not have to obtain the content of the requested web page for the block-or-not determination. Hence, the bandwidth of the network equipment 300 can be saved. Furthermore, if the web page needs to be blocked, the resource of the client 400 and the web server 500 reserved for keeping the connection between them can be saved by the disconnection requests.

Furthermore, if the cloud server 600 determines that the web page does not need to be blocked, the cloud server 600 may transmit the web page request back to the network equipment 300. Then, a web-page-request forwarding module 360 of the network equipment 300 may receive the web page request from the cloud server 600 and forward the web page request, which is received from the cloud server 600, to the web server 500. Subsequently, the web server 500 transmits the web page, which does not need to be blocked, to the client 400 according to the web page request. Therefore, during the cloud server 600 doing the determination, the network equipment 300 does not have to assign extra spaces for storing the web page request from the client 400. In other words, the network equipment 300 can be equipped with memories with smaller storage spaces.

In one embodiment of this invention, the cloud server 600 may transmit the web page request, which does not need to be blocked, to the network equipment 300 through the established tunnel to provide for the web-page-request forwarding module 360 to receive. In practical, the cloud server 600 may pack the web page request into a tunnel packet to transmit to the network equipment 300. Subsequently, when the network equipment 300 receives the tunnel packet with the web page request, the web-page-request forwarding module 360 may retrieve the web page request from the tunnel packet for forwarding to the web server 500.

In one embodiment of this invention, the cloud server 600 may determine if the web page needs to be blocked by determining the address requested in the web page request is listed in a black list or a white list. Hence, the cloud server 600 may include a black-list determining module 610 and a white-list determining module 620. The black-list determining module 610 determines if the address of the requested web page is listed in a black list. If the black-list determining module 610 determines that the address of the requested web page is listed in the black list, the cloud server 600 determines that the requested web page needs to be blocked. The white-list determining module 620 determines if the address of the requested web page is listed in a white list. If the white-list determining module 620 determines that the address of the requested web page is listed in the white list, the cloud server 600 determines that the requested web page does not need to be blocked. Therefore, only the address in the web page request is needed for determining if the web page needs to be blocked or not, which can save calculation resources of the cloud server 600.

In addition, if the address of the web page is listed in neither the black list nor the white list, the cloud server 600 may further obtain the web page from the address of the requested web page for determination. Hence, the cloud server 600 may further include a web-page determining module 630. If the address of the web page is listed in neither the black list nor the white list, the web-page determining module 630 may obtain the requested web page from the web server 500 according to the address of the requested web page. The web-page determining module 630 analyzes the obtained web page to determine if the web page needs to be blocked. If the web-page determining module 630 determines that the web page needs to be blocked after analysis, the web-page determining module 630 adds the address of the web page into the black list. If the web-page determining module 630 determines that the web page does not need to be blocked after analysis, the web-page determining module 630 adds the address of the web page into the white list. Therefore, the address, that the cloud server 600 is able to determine to block or not, can be extended.

The present invention can achieve many advantages. The cloud server can be utilized to assist for determining if request web pages need to be blocked or not. As a result, the network equipment can provide the web page content filtering function even if the network equipment is not equipped with good calculation ability. In addition, the network equipment only needs to transmit the received web page request to the cloud server, but does not have to transmit the content of the requested web page to the cloud server for the block-or-not determination. Hence, the bandwidth of the network equipment can be saved. Furthermore, if the web page needs to be blocked, the resource of the client and the web server reserved for keeping the connection between them can be saved by the disconnection requests.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for filtering web page content comprising:
(a) receiving a web page request, which is utilized to obtain a web page from a web server, from a client through a network equipment after the client builds a connection with the web server;
(b) utilizing the network equipment to transmit the web page request to a cloud server;
(c) utilizing the cloud server to determine if the web page needs to be blocked according to the web page request;
(d) generating a first disconnection request and a second disconnection request according to the web page request if it is determined that the web page needs to be blocked, wherein the first disconnection request is utilized to request the client to disconnect from the web server, and the second disconnection request is utilized to simulate that the client requests to disconnect from the web server; and
(e) transmitting the first disconnection request to the client and transmitting the second disconnection request to the web server through the network equipment, such that the connection between the client and the web server is disconnected.

2. The method for filtering web page content of claim 1 further comprising:
utilizing the network equipment to receive the web page request from the cloud server if the cloud server determines that the web page does not need to be blocked; and
forwarding the web page request, which is received from the cloud server, to the web server, such that the web server transmits the web page to the client according to the web page request.

3. The method for filtering web page content of claim 2 further comprising:
building a tunnel between the network equipment and the cloud server, wherein the network equipment receives the web page request from the cloud server through the tunnel.

4. The method for filtering web page content of claim 1 further comprising:
building a tunnel between the network equipment and the cloud server, wherein the network equipment transmits the web page request to the cloud server through the tunnel.

5. The method for filtering web page content of claim 1, wherein the web page request includes an address of the web page, and the operation (c) comprises:
utilizing the cloud server to determine if the address of the web page is listed in a black list;
determining that the web page needs to be blocked if the address of the web page is listed in the black list;
utilizing the cloud server to determine if the address of the web page is listed in a white list; and
determining that the web page does not need to be blocked if the address of the web page is listed in the white list.

6. The method for filtering web page content of claim 4, further comprising:
utilizing the cloud server to obtain the web page according to the address of the web page if the address of the web page is listed in neither the black list nor the white list;
utilizing the cloud server to analyze the obtained web page to determine if the web page needs to be blocked;
adding the address of the web page into the black list if the cloud server determines that the web page needs to be blocked after the analysis; and
adding the address of the web page into the white list if the cloud server determines that the web page does not need to be blocked after the analysis;

7. A network equipment with a web page content filtering function comprising:
a connection building module, wherein a client builds a connection with a web server through the connection building module;
a web-page-request receiving module for receiving a web page request, which is utilized to obtain a web page from the web server, from the client;
a web-page-request transmitting module for transmitting the web page request to a cloud server, such that the cloud server determines if the web page needs to be blocked according to the web page request;
a disconnecting-request receiving module for receiving a first disconnection request and a second disconnection request from the cloud server if it is determined that the web page needs to be blocked, wherein the first disconnection request is utilized to request the client to disconnect from the web server, and the second disconnection request is utilized to simulate that the client requests to disconnect from the web server; and
a disconnecting-request transmitting module for transmitting the first disconnection request to the client and transmitting the second disconnection request to the web server, such that the connection between the client and the web server is disconnected.

8. The network equipment of claim 7 further comprising:
a web-page-request forwarding module for receiving the web page request from the cloud server and forwarding the web page request, which is received from the cloud server, to the web server if the cloud server determines that the web page does not need to be blocked, such that the web server transmits the web page to the client according to the web page request.

9. The network equipment of claim 8 further comprising:
a tunnel building module for building a tunnel between the network equipment and the cloud server, wherein the web page request is received from the cloud server through the tunnel.

10. The network equipment of claim 7 further comprising:
a tunnel building module for building a tunnel between the network equipment and the cloud server, wherein the web page request is transmitted to the cloud server through the tunnel.
